(19) United States
(12) Patent Application Publication
(10) Pub. No.: US 2004/0030873 A1
(43) Pub. Date: Feb. 12, 2004

(54) Single chip multiprocessing microprocessor having synchronization register file

(76) Inventors: Kyoung Park, Taejon (KR); Sung Hoon Choi, Taejon (KR); Woo Jong Hahn, Taejon (KR); Suk Han Yoon, Taejon (KR)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/429,143

(22) Filed: May 5, 2003

Related U.S. Application Data
(63) Continuation-in-part of application No. 09/389,456, filed on Sep. 3, 1999, now abandoned.

(30) Foreign Application Priority Data
Oct. 22, 1998 (KR) 98-44348

(51) Int. Cl. G06F 9/44

(52) U.S. Cl. 712/245

(57) ABSTRACT

A single chip multiprocessing microprocessor having a synchronization register file is disclosed. This microprocessor includes a plurality of ILP (Instruction Level Parallelism) processors connecting through an internal bus, and a synchronization register file having a multiport so that the ILP processors concurrently access for thereby performing atomic instructions for thereby enhancing the performance of single chip multiprocessing microprocessor and a system using the same by processing atomic instruction without memory access when performing synchronization among internal processors. A single chip multiprocessing microprocessor having a synchronization register file is capable of enhancing the performance of a single chip multiprocessing microprocessor and a system using the same by configuring a system formed using a ring connection network capable of providing a high speed and high bandwidth using a uni-directional input/output separated ring interface apparatus as a chip external interface apparatus instead of a shared bus interface apparatus for thereby overcoming a bottleneck problem occurring in the system of a shared bus architecture.

### CROSS-REFERENCE TO RELATED APPLICATION

This application is a continuation-in-part of prior application for “Single Chip Multiprocessing Microprocessor Having Synchronization Register File” filed on Sep. 3, 1999, there duly assigned Ser. No. 09/389,456, incorporates by reference the same herein, and claims all benefits accruing under 35 U.S.C. §120.

### BACKGROUND OF THE INVENTION

1. Technical Field

The present invention relates to a single chip multiprocessing microprocessor having a synchronization register file which is capable of enhancing a performance of a system by using an ILP (Instruction Level Parallelism) and a TLP (Thread Level Parallelism or Task Level Parallelism) for overcoming a performance limitation of a conventional microprocessor having the ILP.

2. Related Art

Generally commercially available processors are designed to have a superscalar architecture supporting the ILP. The superscalar architecture is directed to an architecture for searching a parallelism among the instructions in a limited instruction window of a single instruction stream and concurrently executing a plurality of instructions. For this, the superscalar architecture is formed of complicated hardware structure to support a branch prediction, a register renaming, an out of order execution, etc. The VLIW architecture, which is another type of the ILP architecture, has a simple hardware structure. The complexity of the hardware is decreased so that a compiler extracts a parallelism among instructions. The performance limitation of the ILP exists in searching a parallelism among the instructions in the limited instruction window. Generally, 4-6 ways are properly used. In the case of more than 8 ways, performance increase cannot be obtained. Therefore, recently, a new microprocessor architecture having a better performance than the ILP has been intensively studied. As a result of the study, a single chip multiprocessing architecture and a multithread architecture are disclosed.

In the single chip multiprocessing architecture, a SMP (Symmetric Multi-processor) system is implemented in a single chip based on the architecture in which a plurality of ILP processors are integrated into one chip. In this case, it is easy to develop a hardware and associated software because well-known and matured techniques are used. In addition, there is an advantage in that it is possible to use the developed sequential programs and SMP programs without modification.

The multithread architecture is directed to concurrently executing a plurality of tightly-coupled threads forming a single process. This architecture is similar with the single chip multiprocessing architecture. However, differently from the single chip multiprocessing architecture, the hardware capable of resolving the dependency problem among threads is provided. In addition, it is not easy to develop software including the compiler.

The structure in which a plurality of processors are integrated into a single chip is known in the industry. As an initial stage, a plurality of ALUs are connected with a predetermined topology in a form of an array processor or a vector processor and is controlled by an externally connected host. After the above-described architecture, another architecture is disclosed, in which a plurality of processing elements each formed of a processor and a memory are integrated. The above-described architecture is used for an accelerator for an image processing, a numerical analysis, etc. Recently, many articles concerning a single chip multiprocessing processor are disclosed, and most of them proposes a basic architecture and do a performance evaluation. In these cases, a plurality of processors are integrated in a single chip based on a first cache sharing type, a second cache sharing type and a memory sharing type. The connection of the internal processors is made by a common bus.

Recently, the single chip multiprocessing architecture is filed by the LSI Co. as a patent. This patent has a synchronization bus, which is used as an interrupt bus for the communications among the processors in the interior of the single chip multiprocessing microprocessor, except for the internal bus. In the multithread architecture, there are the following two cases.

The first architecture is directed to an architecture for fetching a plurality of instructions from a plurality of instruction streams (threads) and then concurrently executing. In this case, the disfetcher fetches instructions from a plurality of instruction streams and issues the same to an operation apparatus. The operation is performed using a register file provided for each thread. This architecture is not directed to an architecture for integrating a plurality of processors. Namely, this architecture is a variant of superscalar architecture in which a plurality of program counters and register files are maintained and a disfetcher controls a plurality of threads.

The second architecture is directed to a superthread method in which a plurality of unit processors, which are called as a thread processor, are integrated, and the thread processors are organized as a thread pipeline. This architecture is directed to a method for forking the threads to a dependent thread processor. For this, the program should be written in superthreading programing model using compiler-directives, and a compiler is needed for recognizing the compiler-directives and generates threads. In addition, each thread processor needs hardware for transmitting a related thread parameter to the other thread processor for implementing a thread fork. Furthermore, in order to resolve the data dependency problems among the threads, a special buffer is additionally needed.

The external interface apparatus for forming the system will be explained as follows. In general, the microprocessor reads a program and its related data from a memory installed outside the microprocessor through a connection network implemented on a PCB and processes the same. A result of the process is stored into the memory through the same network. In addition, in the case that the multiprocessing system is implemented using a plurality of microprocessors, communication traffics including memory accesses, cache coherency protocol transactions and interprocessor communications among microprocessors are done through a connection network implemented on the PCB. In the conventional commercial microprocessor, a bus interface apparatus is generally used for implementing a data transmission/receiving operation for an external communication of the microprocessor. In the case that the system is configured using the conventional microprocessor having a bus interface apparatus, a shared bus structure is used for a connection among the microprocessors and the memory.

The shared bus structure is easy to implement and to adopt snooping cache coherency protocol. However, there is a limit for increasing an operation speed due to the topology characteristic, and shared bus is a bottleneck point in a bus-based system. In addition, since the bandwidth is fixed by an operational frequency and a data transmission width in shared bus system, the scalability of the system is limited. More over, in the case of the microprocessor having an operation speed higher than 1 GHz, the speed difference between the chip interior and the external interface apparatus is increased more. Therefore, it is known that the bottleneck problem occurs at the external interface apparatus.

In order to overcome the above-described problems, Sun Microsystem discloses a UPA (UltraSPARC Port Architecture) technique used for the UltraSPARC microprocessor for thereby connecting maximum four microprocessors in a crossbar architecture, so that it is possible to transmit data at the same operational frequency as the operational frequency of the processor. Beside Sun Microsystem, another microprocessor manufacturing company discloses a sharing bus interface apparatus which operates at below 100 MHz.

The single chip multiprocessing microprocessor architecture is directed to integrating a plurality of processors into one microprocessor. In this architecture, a plurality of instruction streams are processed differently from the conventional single processor type microprocessor. Therefore, there are a plurality of memory access streams, so that a working set of the cache is increased, and thus the amount of external data access requests is increased more than that of the conventional microprocessor. Thus, in the case of the single chip multiprocessing microprocessor, when a bus interface apparatus is used for an external data access, the bottleneck problem is more severe than the single processor type microprocessor. When configuring the system using multiprocessing microprocessor, the bottleneck problem shall occur at the shared bus.

### SUMMARY OF THE INVENTION

In a single chip multiprocessing microprocessor in which a plurality of processors are integrated into a single chip, communication is accomplished using shared data among the internal processors. Atomic instructions with respect to the lock variable are used for a mutual exclusive access for the shared data. Usually the lock variables are located on the outside of the processor and are accessed by memory addressing method, therefore one time of address calculation and two times of memory access (one read operation and one write operation) are required to perform an atomic instruction. Moreover, busy-retry phenomenon can occur for the lock variables. In case of busy-retry, the performance of the single chip multiprocessing microprocessor and the system using the same will be decreased since a lot of atomic instructions occupy the external interface with heavy traffic in order to access the lock variables on the outside of the single chip multiprocessing microprocessor.

Accordingly, it is an object of the present invention to provide a single chip multiprocessing microprocessor having a synchronization register file designed to overcome problems encountered in the conventional art.

It is an object of the present invention to provide a single chip multiprocessing microprocessor having a synchronization register file, which is capable of enhancing the performance of single chip multiprocessing microprocessor and a system using the same by processing an atomic instruction without a memory access when performing synchronization among internal processors. In order to achieve the above objects, there is provided a single chip multiprocessing microprocessor having a synchronization register file which includes a plurality of ILP (Instruction Level Parallelism) processors, an internal bus connecting the ILP processors, and a synchronization exclusive register file having a multiport so that the ILP processors concurrently access for thereby performing atomic instructions.

It is another object of the present invention to provide a single chip multiprocessing microprocessor having a synchronization register file which is capable of enhancing the performance of a single chip multiprocessing microprocessor and a system using the same by configuring a system formed using a ring connection network capable of providing a high speed and high bandwidth using a unidirectional input/output separated ring interface apparatus as a chip external interface apparatus instead of a shared bus interface apparatus for thereby overcoming a bottle neck problem occurring in the system of a shared bus architecture.

In order to achieve the above objects, there is provided a single chip multiprocessing microprocessor having a synchronization register file which includes a second cache controller for processing a memory access request when a request is judged to be for a cache when the ILP processors request a memory access through the internal bus, a ring controller/packet buffer for receiving the memory access request through the internal bus, converting the memory access request which is judged not to be for the cache by the second cache controller, interprocessor communication request and an input/output device access request into a packet, transferring the packet to the packet transmitter and transmitting an externally inputted data to the ILP processors through the internal bus, a packet transmitter for transmitting the thusly converted packet and a packet received from the temporary buffer, and a packet receiver for judging whether the packet is externally received, transferring the packet to the ring controller/packet buffer when the packet is determined as a proper packet and transferring the packet to the transmitter through the temporary buffer when the packet is not determined as a proper packet, whereby it is possible to implement a good scalability for a high speed data transmission and a system configuration and to remove the bottleneck problem.

Additional advantages, objects and other features of the invention will be set forth in part in the description which follows and in part will become apparent to those having ordinary skill in the art upon examination of the following or may be learned from practice of the invention. The objects and advantages of the invention may be realized and attained as particularly leveled out in the appended claims as a result of the experiment compared to the conventional arts.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 illustrates an example single chip multiprocessing microprocessor according to an embodiment of the present invention;

FIG. 2 illustrates an example synchronization register file according to an embodiment of the present invention;

FIG. 3 illustrates an example control/datapath MUX of the synchronization register file according to the present invention;

FIG. 4 illustrates a port controller of the synchronization register file according to the present invention;

FIGS. 5A-5L illustrate an example atomic access operation timing of the synchronization register file in granted case according to an embodiment of the present invention;

FIGS. 6A-6L illustrate an example atomic access operation timing of the synchronization register file in ungranted case according to an embodiment of the present invention;

FIG. 7 is a view of illustrating interface signals between the ILP processors and the synchronization register file according to an embodiment of the present invention;

FIG. 8 is a view illustrating an external input/output signal of a single chip multiprocessing microprocessor according to an embodiment of the present invention; and

FIG. 9 illustrates an example system using a single chip multiprocessing microprocessor according to an embodiment of the present invention.

### DETAILED DESCRIPTION OF THE INVENTION

The embodiments of the present invention will now be explained with reference to the accompanying drawings herein below.

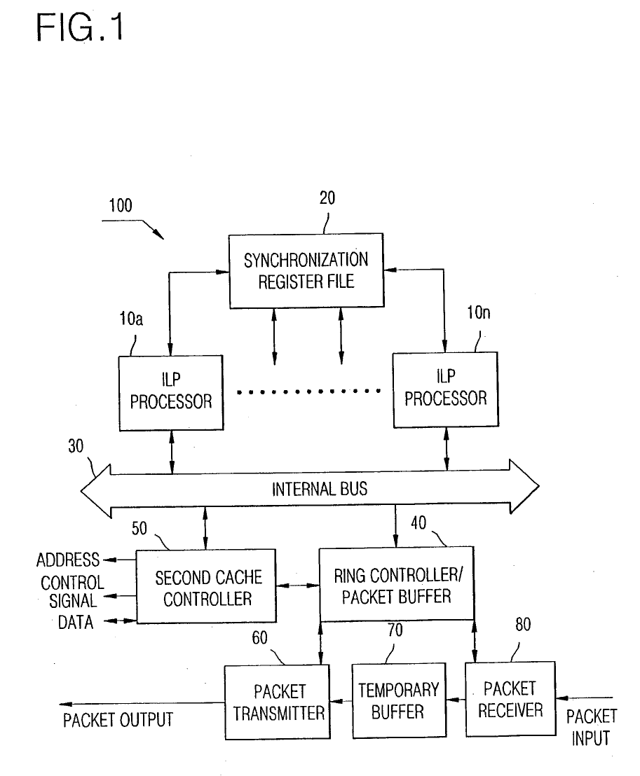

FIG. 1 illustrates an example single chip multiprocessing microprocessor 100 according to an embodiment of the present invention. As shown in FIG. 1, the single chip multiprocessing type microprocessor 10 comprises a plurality of ILP processors 10a-10n, a synchronization register file 20, an internal buse 30, a ring controller/packet buffer 40, a second cache controller 50, a packet transmitter 60, a temporary buffer 70 and a packet receiver 80. The second cache controller 50 and the ring controller/packet buffer 40 are connected using an internal bus 30. The ILP processors 10a-10n perform atomic instructions using the synchronization register file 20 formed of a multiport register file. The ring controller/packet buffer 40 transmits an external data transmission request generated through the internal bus 30, the packet transmitter 60, and externally inputted data is received through the packet receiver 80 and then is transferred to a corresponding ILP processor through the ring controller/packet buffer 40 and the internal bus 30. In addition, data among the data inputted into the packet receiver 80, which does not have a corresponding single chip multiprocessing microprocessor as its destination, is temporarily stored into the temporary buffer 70 and is outputted through the packet transmitter 60.

The ILP processors 10a-10n independently process the thread or task operation. At this time, the ILP processors 10a-10n set the shared data at shared memory positioned outside the chip and communicate each other through the same. Each of the ILP processors 10a-10n uses lock variables for access the shared data and performs atomic instructions such as a fetch and add instruction, a test-and-set instruction, and a compare and swap instruction.

The atomic instructions operate based on a lock variable positioned in the shared memory for thereby requiring one time of address calculation and two times of memory accesses. In addition, in the case that an access competition occurs among the ILP processors 10a-10n, the ILP processors, which do not have access authority, perform busy-retry operations for thereby increasing the traffic.

In order to overcome the above-described phenomenon, according to an embodiment of the present invention, the synchronization exclusive register file 20 is positioned in the interior of the single chip microprocessor for thereby performing atomic instructions.

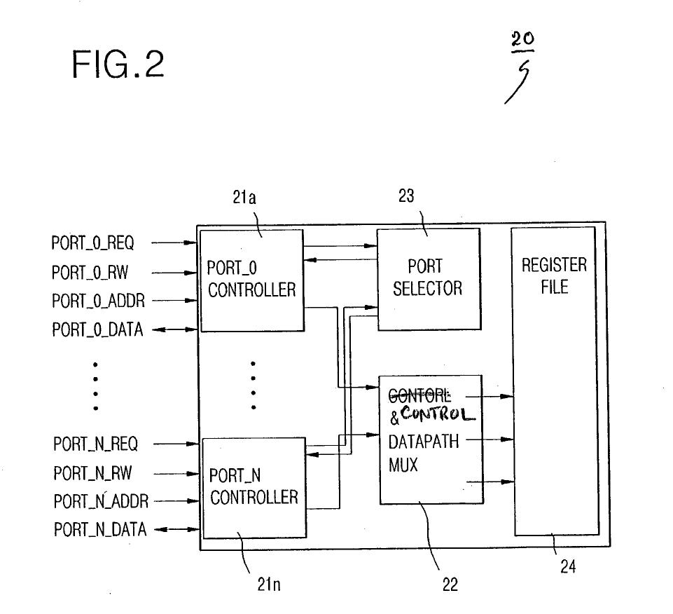

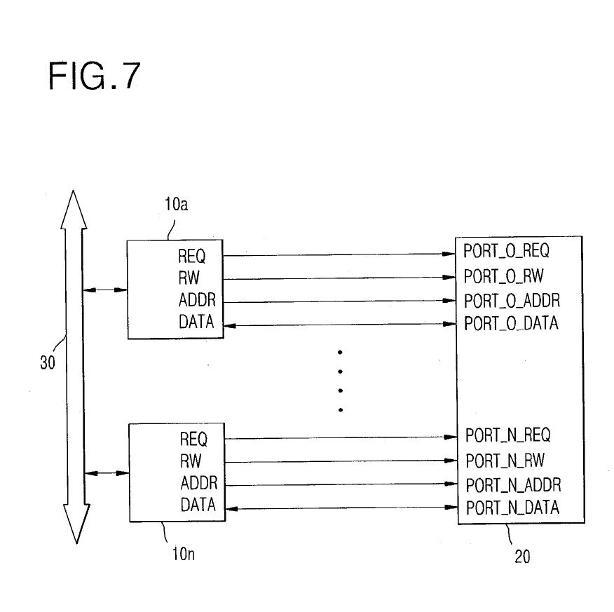

The synchronization register 20 comprises a register files 24 having a plurality of interface ports, as shown in FIG. 2. Each interface port is controlled by the respective port controllers 21a-21n, and is connected to the respective ILP processors 10a-10n on a one-to-one basis, the construction of the connection signal line shown in FIG. 7.

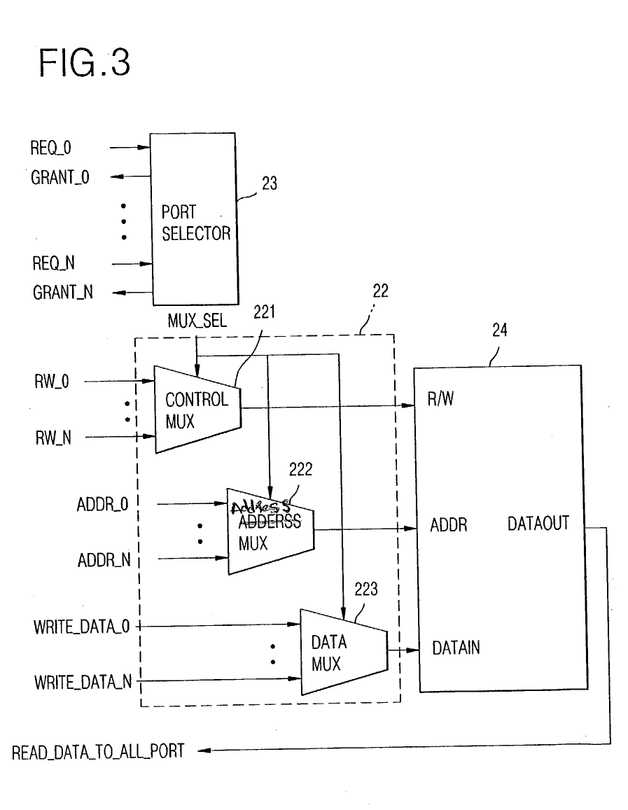

The synchronization register file 20 includes the port controllers 21a-21n, a port selector 23, a control/datapath MUX 22, and the register file 24. The port controllers 21a-21n receive a synchronization register file access request generated from the respective ILP processors, and transmit the request to the port selector 23. The port selector 23 selects any one of access requests generated from a plurality of port controllers 21a-21n, and transmits the access permission to the selected port controller. Simultaneously, the port selector 23 transmits the port selecting result to the control/datapath MUX 22. The control/datapath MUX 22 comprises a control MUX 221, an address MUX 222, and a data MUX 223 as shown in FIG. 3. The control/datapath MUX 22 transmits a read and write control signal, address signals and data signals, which are produced from the port controller 21a-21n acquiring the port access signal by use of the output of the port selector 23, to the register file 24. The register file 24 receives the read and write signal, the address signals and the data signals which are outputted from the control/datapath MUX 22 to perform the read and write operation.

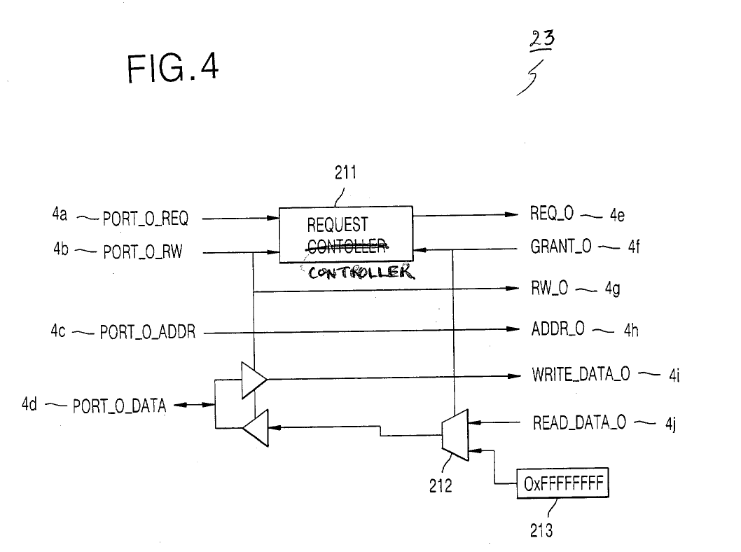

Each of the port controllers 21a-21n includes the same structure, and the operation of the specific port controller 21a will now be described with reference to FIG. 4.

According to “atomic access” of the specific ILP processor 10a, once read and once write are continuously carried out, and the write operation and the read operation are not discrete. The ILP processor 10a drives a signal “Port_{—}0_Req” 4A to request the Atomic access to the synchronization register file 20. During the signal “Port_{—}0_Req” 4A is driven, once read operation and once write operation are sequentially carried out by a read and write control signal “Port_{—}0_RW” 4B, register file address signals “Port_{—}0_Addr” 4C, and data signals “Port_{—}0_Data” 4D.

If the “Atomic access” of the ILP processor is requested by driving the signal “Port_{—}0_Req” 4A, the request controller 211 applies a signal “Req_{—}0” 4E to the port selector 23 to perform the synchronization register file access request. The port selector 23 notifies the port controller of the access permission through the signal “Grant_{—}0” 4F. If the signal “Grant_{—}0” 4F is driven (the Atomic access is permeated), the port controller 21a-21n consequently can perform the normal register file read and write operation through the control/ datapath MUX 22. If the signal “Grant_{—}0” 4F is not driven (the Atomic access is not permeated), at the read operation, the data register 213 returns “0xFFFFFFFF” as a read data instead of accessing register file 24 and the write operation is not transferred to the register file 24, as shown in FIG. 2.

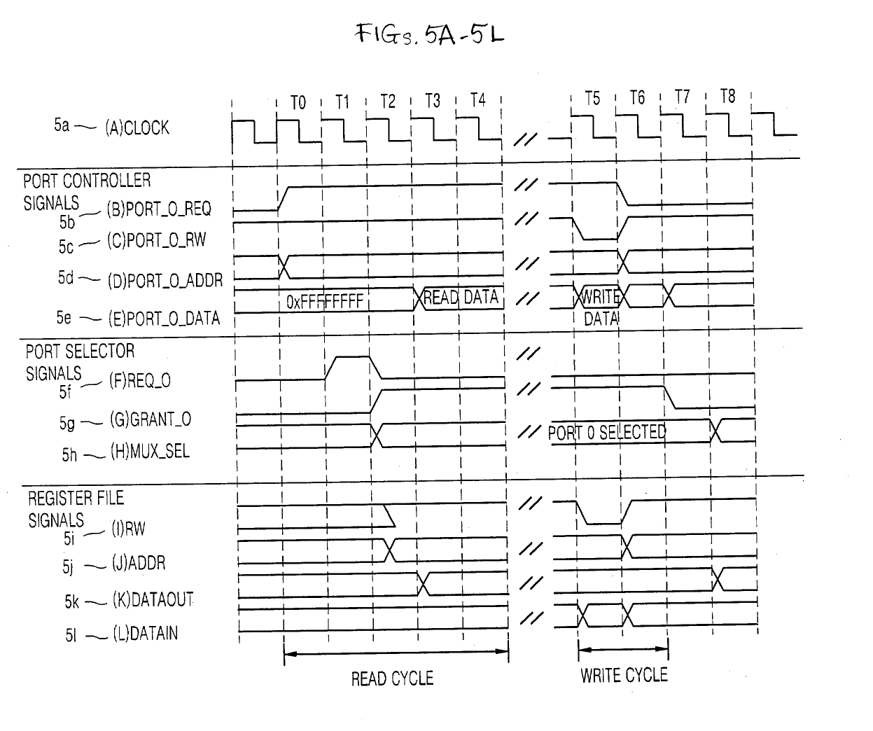

The Atomic access operation of the specific ILP processor 10a will now be described with reference to FIG. 5A to FIG. 5L. The port controller 21a receives the Atomic access request signal “Port_{—}0_Req” shown in FIG. 5B to access the synchronization register file 20 from the ILP processor 10a at clock time T0 and apply the signal “Req_{—}0” shown in FIG. 5F to the port selector 23 at clock time T1.

The port selector 23 receives the signal “Req_{—}0” shown in FIG. 5F, and transmits a signal “Grant_{—}0”, shown in FIG. 5G, notifying the request permission at clock time T2 to the port controller 21a. The port selector 23 drives a signal “Mux_Sel” shown in FIG. 5H to control the control/datapath MUX 22 at clock time T2.

The control/datapath MUX 22 connects signals “Port_{—}0_RW” 5C, “Port_{—}0_Addr” shown in FIG. 5D and “Port_{—}0_Data” 5E which are inputted from the port controller 21a to signals “RW” shown in FIG. 51, “Addr” shown in FIG. 5J, “DataOut” shown in FIG. 5K and “DATAin” shown in FIG. 5L of the resigster files 24, respectively, to perform the register file read and write operation.

If the read and write operation of the ILP processor 10a is consequently completed, the ILP processor 10a de-asserts the signal “Port_{—}0_Req” shown in FIG. 5B at clock time T6, and the port selector 23 de-asserts the signals “Grant_{—}0” shown in FIG. 5G and “Mux_Sel” shown in FIG. 5H at clock time T7, so that the read and write operation by the Atomic access is completed.

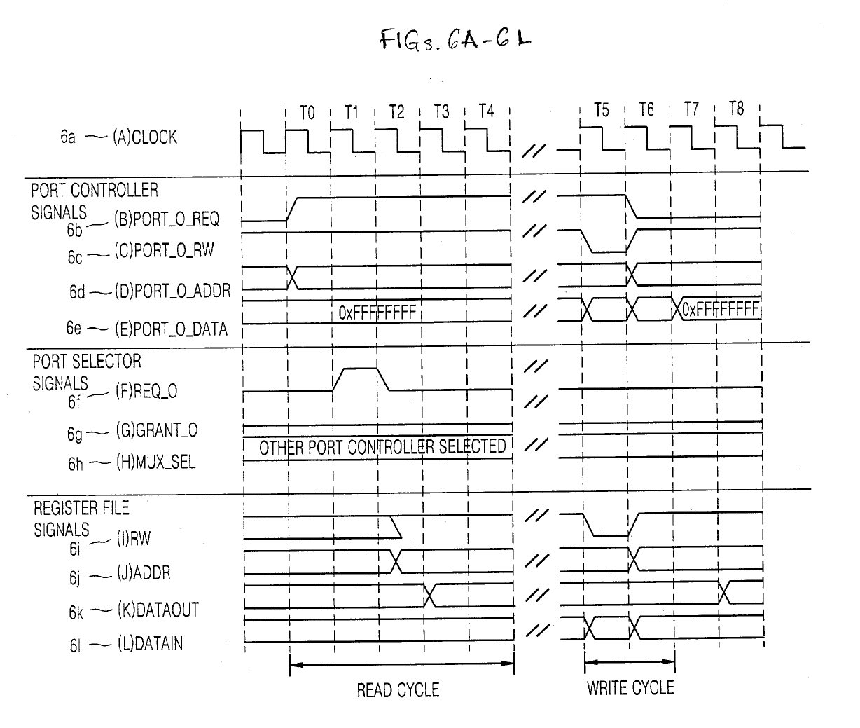

The case that the port selector 23 does not receive the access permission at the Atomic access operation of the specific processor 10a will now be described with reference to FIG. 6A to FIG. 6L as follows.

The port controller 21a receives the Atomic access request signal “Port_{—}0_Req” shown in FIG. 6B to access the synchronization register file 20 from the ILP processor 10a at clock time T0 and apply the signal “Req_{—}0” shown in FIG. 6F to the port selector 23 at clock time T1.

At that time, while the port selector 23 processes the Atomic access by any one of ILP processors 10b-10n or when the port selector 23 denies the access permission according to the arbitration rule that are applied to resolve multiple requests from the ILP processors 10a-10n, the port selector 23 does not drive the signal “Grant_{—}0” shown in FIG. 6G at clock time T2. The signal “Mux_Sel” shown in FIG. 5H, is used in order to set up the datapath between the specific port controller which obtains the access permission at present and the register file 24 through the control/datapath MUX 22. Therefore the signals “Port_{—}0_RW” shown in FIG. 6C, “Port_{—}0_Addr” shown in FIG. 6D and “Port_{—}0_Data” shown in FIG. 6E of the port controller 21a, which do not obtained the access permission, are not transferred to the register file 24.

In response to the read operation to the Atomic access, which does not obtain the access permission, a value of the data register 213 is used and the consequent write operation following the read operation is disregarded.

In the single chip multiprocessing microprocessor according to an embodiment of the present invention, the ILP processors 10a-10n use the synchronization register file 20 for lock variables at implementing the Atomic commands. In order to access the synchronization register file, it has a dedicated access port of the connecting signals as shown in FIG. 7.

The dedicated Atomic commands using the synchronization register file 20 is defined as follows. Likewise, the operation of each command is also defined as follows:

| Name | Syntax | Example |
|---|---|---|
| LSWAP | LSWAP Lreg, | LSWAP LR0, R0, R1 |
| | Reg, Reg | 0^{th} register of synchronization register is read |
| | | and the read result is placed into an internal |
| | | register R0 of ILP processor, |
| | | 0^{th} register of synchronization register is filled |
| | | with a value of an internal register R1 of ILP |
| | | processor. |
| LCAS | LCAS Lreg, | LCAS LR0, R0, R1 |
| | Reg, Reg | 0^{th} register of synchronization register is read |
| | | and compared with an internal register R1 of |
| | | ILP processor, |
| | | if the content is same to each other, 0^{th} register |
| | | of synchronization register is replaced by a |
| | | value of an internal register R1 of ILP |
| | | processor, |
| | | if the content is different from each other, read |
| | | data is written on 0^{th} register of synchronization |
| | | register. |
| LFAD | LTST Lreg, | LFAD LR0, R0, R1 |
| | Reg, Reg | 0^{th} register of synchronization register is read |
| | | and the read result is placed into an internal |
| | | register R0 of ILP processor, |
| | | read data is added by a value of an internal |
| | | register R1 of ILP processor, and is written on |
| | | 0^{th} register of synchronization register. |

The respective commands are processed by the Atomic operation, and once read operation and once write operation are continuously performed through the synchronization register file access port. Lock variable is initialized by means of dedicated Atomic command using the synchronization register, and an example of implementing the lock is as followings:

| | | | |
|---|---|---|---|
| | MOV | R0, #0×0 | // R0 = 0×0 |
| InitLoop | LSWAP | LR0, R1, R0 | // R1 = LR0, LR0 = R0 |
| | CMP | R1, #0×FFFFFFFF | // if (R1=0×FFFFFFFF) |
| | BE | InitLoop | // Atomic Access Failure |
| | | | // Retry |
| | MOV | R0, #0×0 | // R0 = 0×0 |
| | MOV | R1, #0×1 | // R1 = 0×1 |
| Lock | LCAS | LR0, R0, R1 | // tmp = LR0 |
| | | | // if (tmp = R0) |
| | | | // LR0 = R1 |
| | | | // R1 = tmp |
| | | | // else |
| | | | // LR0 = tmp |
| | CMP | R0, R1 | // if (R0=R1) |
| | BNE | Lock | // Lock Failure |
| | | | // Retry |
| | MOV | R0, #0×0 | // R0 = 0×0 |
| UnLock | LSWAP | LR0, R1, R0 | // R1 = LR0, LR0 = R0 |
| | CMP | R1, #0×FFFFFFFF | // if (R1=0×FFFFFFFF) |
| | BE | UnLock | // Atomic Access Failure |
| | | | // Retry |

Since the synchronization register file 20 is used as the lock variables for communication among the ILP processors 10a-10n of the single chip multiprocessing microprocessor, it is possible to eliminate an address calculation and memory access, which occur when performing a conventional atomic instruction for the lock variable. In addition, a busy-retry of the internal bus 30 and the external interface apparatus, which occur during a competition with respect to the lock variable, is removed for thereby enhancing the performance of the single chip multiprocessing microprocessor and the system formed of the same.

The construction and operation of the external interface apparatus of the single chip multiprocessing microprocessor will be explained when a memory access is requested with reference to FIG. 1.

The ILP processors 10a-10n of the single chip multiprocessing microprocessor 100 shown in FIG. 1, generate a memory read or write request to the internal bus 30, and the generated memory request is transferred to the second cache controller 50 and the ring controller/packet buffer 40. The second cache controller 50 judges whether or not the cache is targeted. As a result of the judgement, if the memory request is targeted to the cache, the second cache controller 50 processes a memory request based on the access of the second cache data RAM. If the generated memory request is judged to be missed by the second cache controller 50, or if the cache or memory update request of another microprocessor is generated according to cache coherence protocol, the ring controller/packet buffer 40 converts a corresponding memory request into the packet and transfers to the packet transmitter 60. The transmitter 60 transmits a corresponding packet to the ring connection network.

The process that the data are transmitted from the memory or the other microprocessor will be explained as follows. The packet inputted into the packet receiver 80 is analyzed by the receiver 80 to determine whether or not a packet is received. If a corresponding packet is the packet, which is determined to be received, the packet is received and transferred to the ring controller/packet buffer 40. The ring controller/packet buffer transfers a corresponding packet to the internal bus 30.

If the packet inputted into the receiver 80 is not the packet, which is determined to be received, the packet is transferred to the packet transmitter 60 through the temporary buffer 70. The packet transmitter 60 transfers a corresponding packet to the ring connection network.

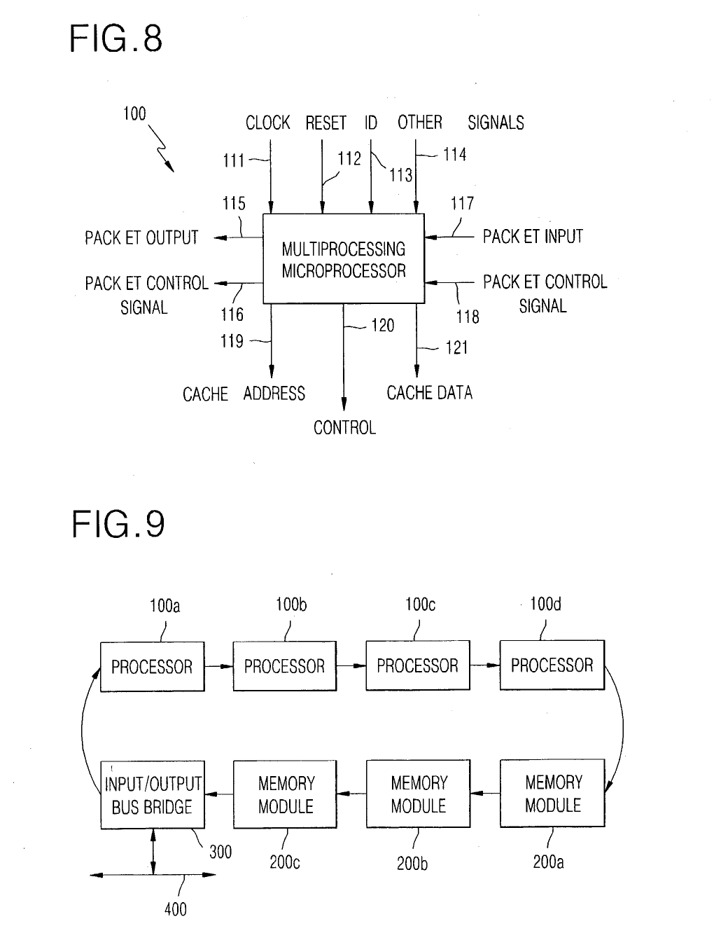

The external input/output signal of the single chip multiprocessing microprocessor 100 having a unidirectional ring interface apparatus is shown in FIG. 8. As shown in FIG. 8, the clock 111 is used as main clock of the microprocessor and is used as an operation clock when transmitting data of the transmitter 60 and the receiver 80. The reset 112 is an initialization signal, and an ID signal 113 is a signal line indicating the position of the single chip multiprocessing microprocessor on the ring connection network, and the other signals 114 are signals for a test and debugging in the single chip multiprocessing microprocessor.

A cache address 119 and a cache data 121 are used for the second cache data RAM access and a control signal 120 is used for controlling the read or write and transmission size.

A packet input 117 and a packet output 115 for a unidirectional input/output separated ring connection network interfacing and packet control signals 118 and 116 having a valid strobe of packet, error information, and flow control information are used.

FIG. 9 illustrates a single chip multiprocessing microprocessor having input/output signals according to an embodiment of the present invention. FIG. 8 shows the same structure as that of FIGS. 1 and 8 and a system formed using the same.

As shown in FIG. 9, the processors 100a, 100b, 100c, and 100d are the single chip multiprocessing microprocessors according to an embodiment of the present invention. In addition, the memory modules 200a, 200b and 200c include the same ring interface apparatus and memory controller. The input/output bus bridge 300 has the same ring interface apparatus and performs a protocol conversion between the ring connection network and the input/output bus 400.

The processors 100a, 100b, 100c, and 100d, the memory modules 200a, 200b and 200c and the input/output bridge 300 forming the system of FIG. 9 each have a uni-directional input/output separated interface apparatus. Each element forming the system is connected with the packet input 117 and the packet control signal 118 of the packet receiver 80 of a corresponding element neighboring with the packet output 115 and the packet control signal 116 of its packed transmitter 60. As described above, a point-to-point connection between the packet output and the packet input of the neighboring elements is implemented. All elements forming the system are connected through a unidirectional ring connection network. The element, which is designed to generate a transmission request, generates a transmission request through the packet output 115 and receives a response corresponding to a corresponding request through the packet input 117. In addition, the corresponding response is transmitted through the packet output 115. Each element forming the system recognizes the position of the ring connection network using an ID signal 113 and is used for forming the destination information and transmitter information. The destination information contained in the inputted packet and the ID 113 are compared for thereby judging whether or not the packet is received.

As described above, in the single chip multiprocessing microprocessor in which a plurality of ILP processors are integrated into a single chip, communication is accomplished using a shared data among the internal ILP processors. Atomic instructions with respect to the lock variable are used for a mutual exclusive access for the shared data. At this time, one time of address calculation and two times of memory access (one read operation and one write operation) are required in order to perform an atomic instruction. In addition, a busy-retry of the internal bus and the external interface apparatus, which occur during a competition with respect to the lock variable, degrades the performance of the single chip multiprocessing microprocessor and the system formed of the same.

In the present invention, in order to overcome the above-described problems, a synchronization register file capable of storing the lock variable is used for thereby performing atomic instructions for the lock variables, so that it is possible to eliminate the address calculation and memory access occurring when the instruction is performed and to prevent the busy-retry problem occurring in the internal bus and the external interface apparatus, and thus the performance of the single chip microprocessor and the system using the same will be increased.

There is the limitation of increasing the operation speed of bus interface due to a difficulty for controlling the transmission delay time and impedance control of the electrical signal due to the architecture of the bus. In addition, the scalability of the system is limited because the bandwidth is fixed by the operation frequency and the width of the transmission data. However, in the present invention, the system is configured using the ring connection network based on the unidirectional point-to-point connection, so that the microprocessor has a unidirectional input/output separated ring interface apparatus for thereby overcoming the disadvantage of the above-described conventional bus structure.

In addition, in the case of the single chip multiprocessing type microprocessor which has been intensively studied as a next generation microprocessor architecture, the amount of the external data transmission/receiving is larger compared to that of conventional microprocessor for thereby causing a bottle neck phenomenon at the external interface apparatus. In the present invention, it is possible to significantly enhance the performance of the single chip multiprocessing type microprocessor by providing an unidirectional input/output separated ring interface apparatus which operates at a high speed frequency for an external data transmission/receiving operation.

Although the preferred embodiments of the present invention have been disclosed for illustrative purposes, those skilled in the art will appreciate that various modifications, additions and substitutions are possible, without departing from the scope and spirit of the invention as recited in the accompanying claims.

What is claimed is:

1. A single chip microprocessor comprising:
a plurality of ILP (Instruction Level Parallelism) processors each having a dedicated interface for a synchronization register file and performing atomic instructions using the synchronization register file without address translation and external memory access, wherein the synchronization register file comprises:
a plurality of ports which interface the ILP processors,
a port selector which selects one of multiple access requests from the ILP processors,
a control/datapath multiplexor which sets up internal signal paths according to an arbitration result of a port selector, and
a register file.

2. The microprocessor as claimed in claim 1, wherein lock variables used for mutually exclusive access for shared data when communications are made among the ILP processors using sharing memory are stored into the synchronization register file for thereby performing atomic instructions using the stored variable without address translation and external memory access.

3. The microprocessor as claimed in claim 1, wherein atomic instructions are used to execute atomic operations without address translation and external memory access, and include:
a LSWAP instruction which swaps a register of the ILP processor and a register of the synchronization register file using atomic operation;
a LCAS instruction which reads out the register of the synchronization register file and compare with the register of the ILP processor, if the values are equal, swaps the register of the ILP register and the register of the synchronization register file; and
a LFAD instruction which reads out the register of the synchronization register file, adds the register of the synchronization register file and the register of the ILP processor and stores the result into the register of the synchronization register file.

4. The microprocessor as claimed in claim 1, further comprising:
a cache controller for processing a memory access request when a request is judged to be for a cache when the ILP processors request a memory access through an internal bus;
a ring controller/packet buffer for receiving the memory access request through the internal bus, converting the memory access request which is judged not to be for the cache by the cache controller, a communication request among the ILP processors and an input/output devices access request into a packet, and transmitting externally inputted data to the ILP processors through the internal bus;
a packet transmitter for transmitting the converted packet and a packet received from a temporary buffer; and
a packet receiver for judging whether the packet is received, transferring the packet to the ring controller/packet buffer when the packet is determined as a proper packet and transferring the packet to the packet transmitter through the temporary buffer when the packet is not determined as a proper packet.

5. A single chip microprocessor comprising:
a synchronization register file; and
a plurality of instruction level parallelism (ILP) processors organized in a thread pipeline to independently process one or more threads or task operations, each of the ILP processors performs atomic instructions using the synchronization register file as lock variables for a mutual exclusive access of data in a shared memory,
wherein the synchronization register file comprises:
a plurality of ports to interface the ILP processors;
a port selector to select one of multiple access requests from the ILP processors;
a control/datapath multiplexor to establish internal signal paths according to an arbitration result of a port selector; and
a register file to enable a read and write operation according to signals from the control/datapath multiplexor.

6. The microprocessor as claimed in claim 5, wherein the lock variables used for mutually exclusive access of data in the shared memory and obtained from the ILP processors using the shared memory are stored in the synchronization register file for enabling execution of the atomic instructions using the stored lock variables without address translation and external memory access.

7. The microprocessor as claimed in claim 5, wherein the atomic instructions are used to execute atomic operations without address translation and external memory access, and include:
a LSWAP instruction which swaps a register of the ILP processor and a register of the synchronization register file using atomic operation;
a LCAS instruction which reads out the register of the synchronization register file and compare with the register of the ILP processor, if the values are equal, swaps the register of the ILP register and the register of the synchronization register file; and
a LFAD instruction which reads out the register of the synchronization register file, adds the register of the synchronization register file and the register of the ILP processor and stores the result into the register of the synchronization register file.

8. The microprocessor as claimed in claim 5, further comprising:
a cache controller to process a memory access request when a request is determined for a cache after the ILP processors request a memory access through an internal bus;
a ring controller/packet buffer to receive the memory access request through the internal bus, and convert the memory access request which is determined not for the cache by the cache controller into a packet;
a packet transmitter to transmit the converted packet and a packet received from a temporary buffer; and
a packet receiver to determine if the packet is received, transfer the packet to the ring controller/packet buffer when the packet is determined as a proper packet and transfer the packet to the packet transmitter through the temporary buffer when the packet is determined as not a proper packet.
